(19) United States
(12) Patent Application Publication
(10) Pub. No.: US 2003/0098356 A1
(43) Pub. Date: May 29, 2003

(54) Emergency health history kit and method of advertising and distributing the same

(76) Inventor: George J. Gombar, Los Angeles, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/307,045

(22) Filed: Nov. 27, 2002

Related U.S. Application Data
(60) Provisional application No. 60/334,265, filed on Nov. 29, 2001.

(51) Int. Cl. G06K 19/06

(52) U.S. Cl. 235/492; 206/232; 206/38

(57) ABSTRACT

An emergency health history kit includes a housing which may be a transparent or translucent plastic case, or a paper envelope. At least one medical and emergency information card is disposed within the housing. Such cards include printed prompts and spaces for filling in personally identifying information, medical history information and medical care provider information for that individual. To offset the cost of the emergency health history kit, and enable it to be given as a promotional item free of charge, a sponsor or distributor identifying indicia is imprinted or otherwise associated with the housing, and at least one redeemable coupon or printed offer is disposed within the housing.

### RELATED APPLICATION

This application claims priority from U.S. Provisional Application No. 60/334,265, filed Nov. 29, 2001.

### BACKGROUND OF THE INVENTION

The present invention generally relates to health history information and medical emergencies. More particularly, the present invention relates to a method of advertising and distributing health history kits useable in medical emergency situations, and which also can be the vehicle of fundraising and promotions and/or community service programs.

When firefighters, paramedics, and emergency medical technicians answer an emergency call and a victim is either unconscious or has difficulty in communicating their physical condition, administrating even basic medical treatment can be difficult. On the road at the scene of a traffic accident, or in the home at a residential emergency, responding medical technicians could more appropriately treat the victims and save more lives if medical history and other emergency information were readily available and easily accessible.

Many years ago, a medical and emergency information program designed for senior citizens was introduced onto the market. The concept was to make available to emergency personnel a senior citizens vital medical and emergency information at the scene where it is most needed. The emergency information of the user was compiled on a preprinted sheet of paper, placed in a specimen vile, and then stored permanently in the refrigerator of the senior citizens own home. The refrigerator was selected as the storage container because it is fire resistant, centrally located, and commonly checked by firefighters and paramedics for medications that may be taken by a victim. Soon thereafter, a marketing and advertising company expanded the program to include all members of a household. Again, the item was stored in the refrigerator, but this time the container, being a clear plastic case about the size of a business card, was promoted as an advertising tool first and a life saving tool second. The product was offered into the market place by specialty advertising companies and used as an advertising/promotional tool. However, even though the program was expanded to include all occupants of a home, and the product itself was modified so as to be a good advertising tool, it again failed. Users complained that the program suffered from lack of community awareness and advertisers balked at the cost of the item saying it was too expensive to use as a promotional tool.

Accordingly, there remains a continuing need for a method of advertising, promoting and distributing health history kits in a large number so that the information within such kits can be readily available to medical emergency personnel. The present invention fulfills this need and provides other related advantages.

### SUMMARY OF THE INVENTION

The inventor has determined that in order for a program distributing medical health history kits to succeed as a marketing and advertising tool, numerous hurdles have to be overcome. First, it is necessary to find a flagship distributor that has both the desire and ability to distribute the product throughout the entire community. Second, the distributor must be in a position to benefit from name to logo identification associated with having their message prominently displayed in homes throughout the communities they serve. Third, the distributor has to have a high enough visibility in the community so that it can generate wide spread publicity for the program, and at the same time profit from the publicity generated through public service announcements on radio and television along with articles in local, regional and state publications. And finally, because of the high costs associated with the health history kit, and other costs associated with such a dynamic promotion, the distributor needs to defray it's costs by forming a partnership with other interested advertisers.

The present invention fulfills these needs by providing in an emergency health history kit and a method of distributing and advertising the same so as to readily make such available to medical emergency personnel.

The emergency health history kit includes a housing which may be comprised of a transparent or translucent plastic case in one embodiment, or a paper envelope in a second embodiment. Preferably, a sponsor's or distributor's identifying indicia is imprinted onto the housing, or may be imprinted onto a card which is readily viewable through the transparent plastic case. Typically, the housing is approximately between three inches and six inches in dimension so as to be easily stored in a glove compartment of a vehicle, or attached on or placed in a refrigerator or the like.

At least one, and preferably many, medical and emergency information cards are disposed within the housing. Such medical and emergency information cards include printed or written prompts and spaces which are to be filled out by the individual in order to provide that individual's personally identifying information, medical history information, medical insurance information, and medical care provider information. In the event of an emergency, emergency medical personnel can retrieve the emergency health history kit and use the medical and emergency information card to identify the patient, and properly treat the patient using the medical history information and medical care provider information on the card.

In a particularly preferred embodiment, the emergency health history kit is given away as a promotional item by the sponsor and/or the distributor. The sponsor or distributor has its name or logo printed on the housing, or viewable therethrough, as an advertising mechanism for the sponsor or distributor. Thus, the sponsor or distributor is willing to pay a portion of the cost of the health history kit. Additionally, at least one redeemable coupon or printed offer is disposed within the housing. Such coupons or offers may be from the sponsor or distributor, or third party vendors as a secondary means of offsetting the cost of producing and distributing the emergency health history kit.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top plan view of a health history kit embodying the present invention;

FIG. 2 is a front perspective view of the health history kit of FIG. 1;

FIG. 3 is a perspective view of the health history kit illustrating a case thereof in an opened state;

FIG. 4 is a perspective view of the health history kit with internal contents removed from the case;

FIG. 5 is a perspective view of medical and emergency information cards, coupons and a card bearing a sponsor's or distributor's identifying indicia in accordance with the present invention;

FIG. 6 is an enlarged view of area “6” of FIG. 5, illustrating printed prompts and spaces on the medical information cards;

FIG. 7 is a top plan view of a second embodiment of the health history kit of the present invention;

FIG. 8 is a front perspective view of the health history kit of FIG. 7;

FIG. 9 is a rear perspective view of the health history kit of FIG. 7, illustrating medical and emergency information cards and coupons within the envelope; and

FIG. 10 is a perspective view illustrating the removal of such cards and coupons from the envelope housing.

### DETAILED DESCRIPTION OF THE PREFERRED EMBODIMENTS

As shown in the drawings for purposes of illustration, the present invention resides in an emergency health history kit 10 and 12 which stores medical emergency information, is capable of being stored in a convenient location which will be readily searchable by emergency personnel, and which incorporates distribution and advertising incentives such that the health history kit 10 and 12 can be distributed widely among the public.

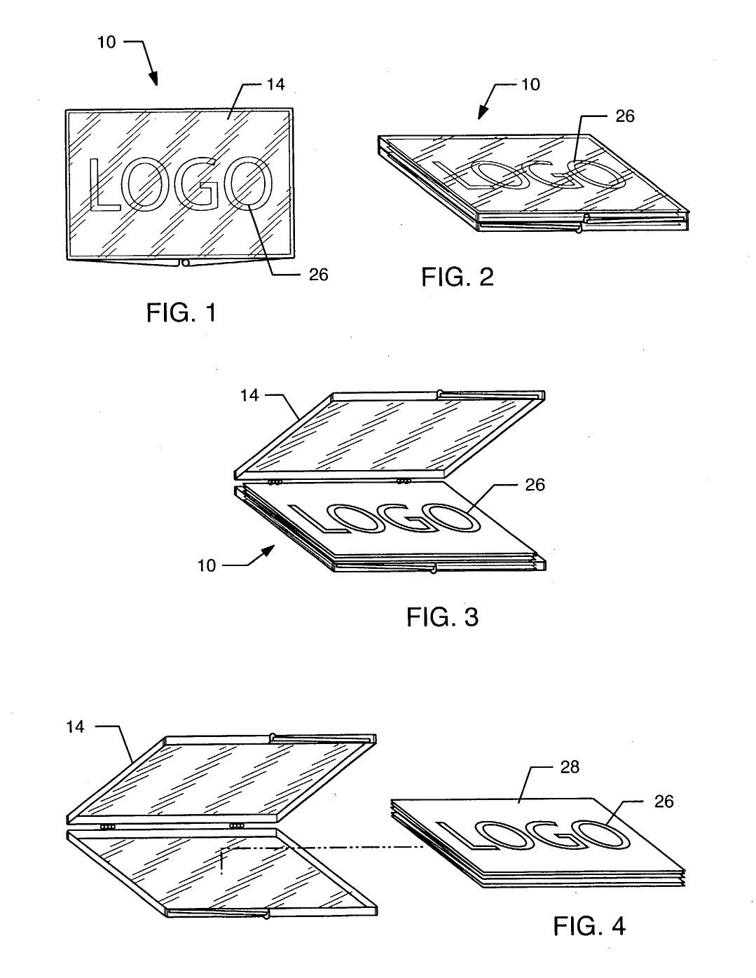

With reference to FIGS. 1-4, the kit 10, in a first preferred embodiment, includes a housing comprising a plastic case 14. The plastic case 14 is preferably translucent or transparent in order to enable the viewing of the contents therein, although such is not necessary. The case 14 is typically small so as to be easily stored within or on a refrigerator, or the like, or within one's glove box of an automobile. Typically, the case 14 is between three and six inches in length and width. The invention contemplates the use of a double-sided adhesive for attaching the case 14, and its contents within or on a refrigerator, or the like so as to be easily viewed by emergency personnel. The refrigerator or a glove compartment of a vehicle are preferable locations for the health history kit 10 and 12 as emergency health personnel are already trained to search such locations in an attempt to find prescriptions or other personal information.

In the illustrated preferred embodiment, the case 14 comprises a square or rectangular case of translucent or transparent plastic material which is hinged so as to be selectively opened and closed in order to access the contents therein. The use of the plastic case 14 as the housing is preferred in the residential setting as such a case 14 can be inserted within a refrigerator and protect the contents within the case 14 from excess moisture in the refrigerator and the like.

With reference now to FIGS. 8-10, the housing need not comprise a plastic case 14, as described above, but rather can comprise a paper envelope 16 of approximately the same dimensions described above in order to be stored in a glove compartment of a vehicle, or on or within a refrigerator. Such paper envelopes 16 are particularly adapted for use in the glove compartment of a vehicle as they are small and compact, and do not generate noise during driving of the vehicle. Such paper envelopes 16 include an open end 18 for removal of the contents thereof.

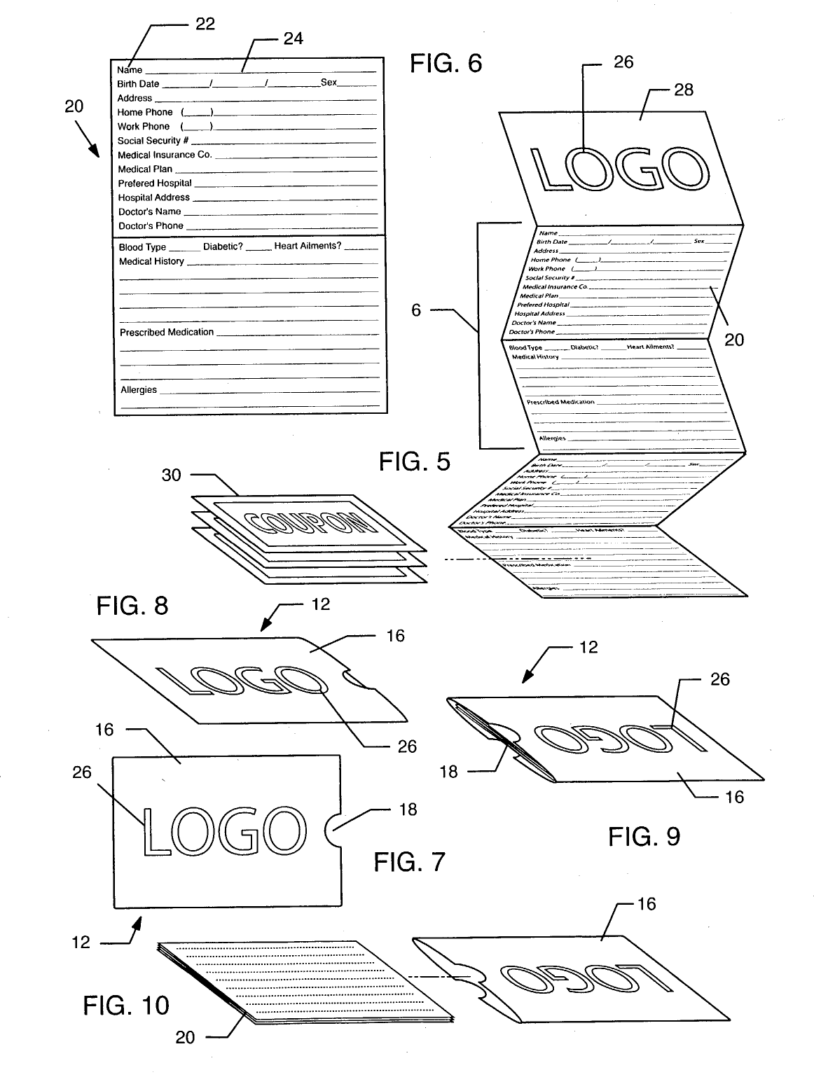

With reference now to FIGS. 4-6 and 10, the case 14 or envelope 16 contains at least one, and preferably four, medical and emergency information cards 20. With particular reference to FIG. 6, each card 20 includes printed prompts 22 and a space 24 to be filled out by the individual to provide the prompted information.

The medical emergency information cards 20 require the user to complete the cards by providing information that may include, but not to be limited to: their name, date of birth, sex, home address, home and office telephone numbers, medical insurance company, medical insurance plan number, name and address of the preferred hospital, the name and telephone number of their primary physician. Additionally, each medical information card 20 may require the user to provide their blood type, and indicate whether or not they have various health ailments, a brief detail of their medical history, prescribed medications, and allergies they suffer from. Space may also be provided for the name, address and telephone number of a friend or relative designated to contact in the event of an emergency. Preferably, printed directly above the space provided for the emergency contact is the following warning: “Contact your doctor before completing medical information cards. Complete all forms in pencil, keep all data up to date and accurate”.

The user is instructed to either place the kit in or on the refrigerator, or within the glove compartment of his or her automobile. Thus, the health history kit 10 and 12 of the present invention enables its users to keep “on file” their pertinent medical emergency information. Responding emergency personnel are provided with vital emergency information at the scene, where it is most needed.

In addition to being a life saving tool, the kit of the present invention 10 and 12 is also designed as a specialty advertising and promotional tool. Every kit 10 and 12 whether it be made of plastic, paper or any other material, allows for the distributing advertiser to have its identifying indicia in the form of its company name, logo and/or message 26 prominently displayed on the face of the case 14. The identifying indicia or message 26 can be imprinted directly onto the case 14 or paper envelope 16, or imprinted upon a card 28 which is viewable through the clear case 14. In either event, the logo or message 26 is intended to be viewed predominantly when viewing the kit 10 or 12. This concept enables the advertiser to permanently advertise its message to clients and/or perspective clients, and at the same time establish itself as a goodwill company in the community it serves.

The kits 10 and 12 are intended to be manufactured and then assembled under the direction of an issuing company. The kit 10 or 12, its manufacture, assembly, design, layout and other aspects of the product and the promotion will be negotiated between the issuing manufacturer and the distributor, and perhaps one or more sponsors. The kits 10 or 12 are intended to be manufactured and assembled exclusively for and on behalf of the distributor. The distributor in this instance is the company that distributes or assists in the distribution of the kits 10 or 12 into the community. For example, the distributor may be a grocery chain, gas and service station chain, fast food restaurant, or the like. Such distributors would be ideal as a great number of consumers visit such locations on a regular basis. The distributor need not be limited to such locations, but can be any company looking for an advertising, promotional, or goodwill tool, such as an insurance company.

Additionally, the kit 10 or 12 is intended to be cross-marketed. In order to defray the costs of producing the kits 10 or 12, advertising messages, redeemable coupons or other offers 30 from one or more sponsors are included within the kit 10 or 12. Such cross-marketing is believed to enable the kits 10 or 12 to be offered by the distributor at a significantly reduced rate, or even enable the distributor to give the kit 10 or 12 away as a promotional item. It is believed that this will enable the kits 10 or 12 to be distributed on a much larger scale, and yet be economically feasible for the participating distributors and sponsors.

A sponsor may negotiate a price with the manufacturer and/or distributor to have their coupons 30 included in the kit 10 or 12. The costs associated with the production, printing, and insertion of the sponsor's coupon 30 into the kit 10 or 12 will be negotiated between the sponsor and the manufacturer and/or distributor. A sponsor may act as a distributor in the distribution of the kits 10 and 12. For example, the grocery chain may in fact offer “in house” coupons 30 for produce, meats, house brands, etc., along with home safety products such as burn ointments, band-aids, flashlights, batteries, etc. The distributor/sponsor can choose a peak shopping holiday to tie in the promotion. An example would be Thanksgiving or the Fourth of July. Alternatively, the distributor may seek sponsors having tie in products with their business. For example, a gas service station may desire to have coupons 30 from sponsors for oil, candy, auto repair, auto rental, etc.

The company purchasing the kits 10 or 12 may not in fact be the company actually distributing the kits 10 or 12. For example, Coca Cola® may desire to purchase the kits 10 and 12 and have various grocery chains, restaurants, or the like distribute the kits 10 and 12. Coca Cola® could defray its costs by not only including sponsor's coupons, but also negotiating space on the cover of the kit 10 or 12 with the company actually distributing the kits 10 and 12. The distributor can maintain the right to partner with one or more sponsors so as to lower its costs of the product and the promotion. The distributor may also maintain the right to partner with numerous sponsors so as to completely eliminate the cost of the product, or even generate revenue from its sponsor or sponsors that exceeds the price of the kits 10 and 12. This provides a tremendous incentive for the distributor to carry and give away the kits 10 and 12 to the consumers.

The present invention provides a distributor with the unique and innovative array of marketing and advertising benefits that, when combined, creates a concept which has never been equaled in the specialty advertising promotional industry. As discussed above, the distributor's name, company logo and/or message 26 will be prominently displayed on the refrigerator door in the user's residence and/or in the glove compartment of user's automobiles for a prolonged period of time, and possibly for the life of the individual.

The manufacturer of the product will encourage and may assist the distributor to contact local, regional and state newspapers, radio and television stations to announce their participation in the program as a public service announcement. Local and state fire and emergency personnel may be requested to conduct a press conference to publicize the promotion. Such advertising costs the distributor nothing but comes with the tremendous goodwill and advertising. Additionally, the program serves as a public service as the public is educated and given the opportunity to obtain a potentially life saving product.

The distributor has the option of choosing the day, week or month of the promotion, and may tie the promotion into a shopping holiday or the like as described above, in order to increase foot traffic which will result in additional business.

Due to the fact that the one or more distributors may contract with one or more sponsors to include either their logos or messages 26 or coupons 30, the cost of the kits 10 and 12 can be significantly reduced preferably to zero, or even become a money making venture. In the event that money is made from the promotion, the distributor may choose to donate the proceeds to a charitable organization, further establishing goodwill in the community.

Although several embodiments have been described in some detail for purposes of illustration, various modifications may be made without departing from the scope and spirit of the invention. Accordingly, the invention is not to be limited, except as by the appended claims.

What is claimed is:

1. An emergency health history kit, comprising:
a housing;
at least one medical and emergency information card disposed within the housing and including printed prompts and spaces for personally identifying information, medical history information, and medical care provider information; and
at least one redeemable coupon or printed offer disposed within the housing.

2. The kit of claim 1, wherein the housing comprises a transparent or translucent plastic case.

3. The kit of claim 2, wherein the case is approximately between three inches and six inches in dimension.

4. The kit of claim 2, including a sponsor's or distributor's identifying indicia imprinted on the case.

5. The kit of claim 2, including a sponsor's or distributor's identifying indicia imprinted on a card disposed within the case so as to be viewable through the case.

6. The kit of claim 1, wherein the housing comprises a paper envelope.

7. The kit of claim 6, wherein the envelope is approximately between three inches and six inches in dimension.

8. The kit of claim 6, including a sponsor's or distributor's identifying indicia imprinted on the envelope.

9. An emergency health history kit, comprising:
a transparent or translucent plastic case;
at least one medical and emergency information card disposed within the case;
a sponsor's or distributor's identifying indicia imprinted on the case, or on a card disposed within the case so as to be viewable through the case; and
at least one redeemable coupon or printed offer disposed within the case.

10. The kit of claim 9, wherein the case is approximately between three inches and six inches in dimension.

11. The kit of claim 9, wherein the medical and emergency information card includes written prompts and spaces for personally identifying information.

12. The kit of claim 11, wherein the medical and emergency information card further includes written prompts and spaces for personal medical information, including personal medical history information, medical insurance information, and medical care provider information.

13. An emergency health history kit, comprising:
a paper envelope having a sponsor's or distributor's identifying indicia imprinted thereon;
at least one medical and emergency information card disposed within the envelope; and
at least one redeemable coupon or printed offer disposed within the envelope.

14. The kit of claim 13, wherein the envelope is approximately between three inches and six inches in dimension.

15. The kit of claim 13, wherein the medical and emergency information card includes written prompts and spaces for personally identifying information.

16. The kit of claim 15, wherein the medical and emergency information card further includes written prompts and spaces for personal medical information, including personal medical history information, medical insurance information, and medical care provider information.
